(19) United States
(12) Patent Application Publication
(10) Pub. No.: US 2026/0357059 A1
(43) Pub. Date: Nov. 12, 2026

(54) PLASTIC PREFORM, CONTAINER, AND METHOD

(71) Applicant: PLASTIPAK PACKAGING, INC., Plymouth, MI (US)

(72) Inventor: Miguel Vieira, Vilvoorde (BE)

(21) Appl. No.: 19/662,910

(22) Filed: Apr. 29, 2026

Related U.S. Application Data
(60) Provisional application No. 63/800,880, filed on May 6, 2025.

(51) Int. Cl. C08L 67/02; B29C 49/06; B29C 49/12; B29K 67/00; B29K 105/26; B29L 31/00; B65D 1/02

(52) U.S. Cl. CPC C08L 67/02; B29C 49/06; B29C 49/12; B29K 2067/003; B29K 2105/26; B29L 2031/712; B65D 1/0207; C08L 2201/14; C08L 2205/025; C08L 2205/03; C08L 2207/20

(57) ABSTRACT

A plastic preform or container composition includes a combination of bis(2-hydroxyethyl) terephthalate (BHET), polyethylene furanoate (PEF) or furandicarboxylic acid (FDCA), and recycled polyethylene terephthalate (rPET). In embodiments, the BHET is in a range of about 5 mol% to about 95 mol%; the PEF or FDCA is in a range of about 1 mol% to about 10 mol%; and the rPET is in a range of about 5 mol% to about 95 mol%. Embodiments of preforms may be formed from the disclosed composition. Such preforms may be subject to total stretch ratios exceeding 18.5 in connection with the formation of resultant containers.

### CROSS-REFERENCE TO RELATED APPLICATION

This application claims the benefit of U.S. Provisional Patent Application No. 63/800,880, filed May 6, 2025, the entire disclosure of which is incorporated herein by reference.

### TECHNICAL FIELD

The present disclosure relates to preforms or containers including those comprising BHET, PEF/FDCA, and recycled PET, and methods relating to such preforms or containers.

### BACKGROUND

Plastic preforms and containers are widely employed in the industry. A number of plastic containers are formed from plastic preforms via an injection stretch blow molding (ISBM) process. Such a process is commonly used in connection with polyethylene terephthalate (PET). The stretching of material, such as PET, can be a significant step to enhance, inter alia, mechanical properties, e.g., strength and/or impact resistance, and clarity in final products. Stretching may occur in connection with the blow molding stage, where a preform is heated to an appropriate temperature and is then stretched in an axial direction by a stretch rod. Biaxial stretching may be achieved as compressed air or gas is introduced to expand the preform against mold walls, which can result in biaxial stretching. However, there can be limits to stretching associated with PET preforms and resulting containers. For example, with PET ISBM, depending on preform design, axial stretch ratios may typically range from 1.5:1 to 3.2:1, and radial stretch ratios may typically range from 2.5:1 to 5.5:1. Further, for example, with a 20 ounce PET bottle, the overall/total stretch ratio may typically fall within a range of about 3.75:1 to 17.6:1. Stretching beyond typical ranges can result in loss of molecular orientation and can lead to weaker, more brittle, and less transparent containers.

Among other things, it can be desirable to provide plastic (e.g., PET) preforms and containers, which may have improved compositions, may involve improved processing, and may result in desirable final containers.

### SUMMARY

A plastic preform or container composition includes a combination of bis(2-hydroxyethyl) terephthalate (BHET), polyethylene furanoate (PEF) or furandicarboxylic acid (FDCA), and recycled polyethylene terephthalate (rPET). In embodiments, the BHET is in a range of about 5 mol% to about 95 mol%; the PEF or FDCA is in a range of about 1 mol% to about 10 mol%; and the rPET is in a range of about 5 mol% to about 95 mol%. Embodiments of preforms may be formed from the disclosed composition. Such preforms may, for example, be subject to total stretch ratios exceeding 18.5 in connection with the formation of resultant containers.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 generally illustrates an embodiment of a plastic preform;

FIG. 2 generally illustrates a cross-sectional view of another embodiment of a plastic preform; and

FIG. 3 generally illustrates an embodiment of a plastic container.

### DETAILED DESCRIPTION

Reference will now be made in detail to embodiments of the present disclosure, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined herein and by appended claims.

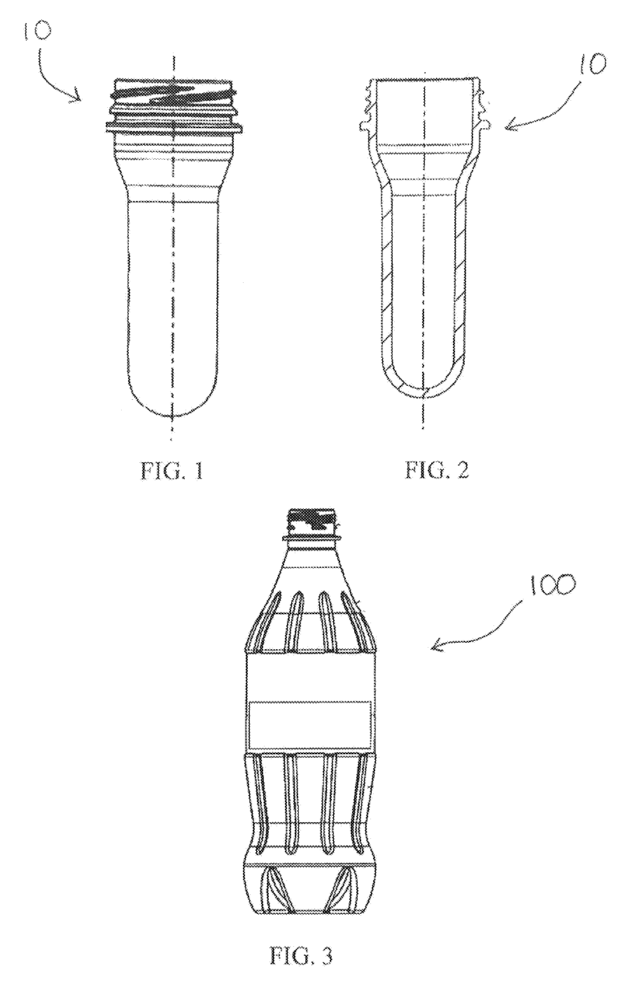

Embodiments of a plastic preform 10 are generally illustrated in FIGS. 1 and 2. An embodiment of a plastic container 100, which may be formed from a plastic preform, such as generally illustrated in FIGS. 1 and 2, is generally illustrated in FIG. 3. The preform and container embodiments illustrated in the figures are provided for exemplary purposes only and are not intended to be limiting. In some embodiments, the preform includes a finish portion, a neck portion, a body portion, and a closed end portion. In some embodiments, the container includes a finish, a shoulder, a body, and a base. It will be understood by those of skill in the art that various modifications, alterations, and variations in design, shape, dimensions, materials, and manufacturing processes may be made without departing from the spirit and scope of the invention.

In embodiments, a PET resin is provided for use, such as in connection with preforms and resulting containers. In an embodiment, the PET resin or composition may comprise a combination of bis(2-hydroxyethyl) terephthalate (BHET), polyethylene furanoate (PEF) / furandicarboxylic acid (FDCA), and recycled PET (rPET), which may be in the form of flakes. The rPET may be post-consumer recycled PET (or PCR PET).

Without limitation, in an embodiment, an amount of BHET may range from about 5 mol% to about 95 mol%; an amount of PEF/FDCA may range from about 1 mol% to about 10 mol%; and an amount of recycled PET (e.g., flakes) may range from about 5 mol% to about 95 mol%. In some embodiments, an amount of BHET may range from 5 mol% to 95 mol%; an amount of PEF/FDCA may range from 1 mol% to 10 mol%; and an amount of recycled PET (e.g., flakes) may range from 5 mol% to 95 mol%. In some embodiments, a range of 2 mol% to 5 mol% PEF may be used; and, in other embodiments, a range of 3 mol% to 5 mol% PEF may be used. Such pre-polymers may be fed in melt or may be in feedstock for other polymers. While the foregoing combination of BHET, PEF/FDCA, and rPET, may be found in monolayer form, such a combination may also be employed in some embodiments with one or more additional layers to be provided or utilized in a multilayer form. In some embodiments, the disclosed composition may form substantially the entire wall thickness of a monolayer preform or monolayer container. In some embodiments, the disclosed composition may form one layer of a multilayer preform or multilayer container, such as an inner layer, an outer layer, or an intermediate layer. In such embodiments, one or more additional layers may comprise PET, virgin PET, recycled PET, copolyester, polyester blend, barrier material, regrind-containing polyester, or other compatible polymeric material.

As used herein, the term "%mol" or "mole percent" refers to the relative proportion of a component in a mixture, composition, or formulation, expressed as a percentage based on the number of moles of that component in relation to the total number of moles of all components present. Where ranges are specified using %mol, such ranges are intended to include all subranges and individual values therein, unless clearly excluded by context.

In embodiments of the process, recycled PET may be washed, ground, and melted. At some point during the melting phase, or sometime after the melting phase, BHET and PEF or FDCA may be added to the melted PET. The modified PET resin may subsequently be formed into preforms, and such preforms may be provided in a wide variety of sizes, shapes, and configurations. In some embodiments, BHET and FDCA may be provided as monomeric or oligomeric species that react to form polyester repeat units in the resin; in other embodiments, PEF may be provided as a pre-formed polymer blended with rPET.

Such preforms may then be formed into resultant containers, such as by injection stretch blow molding (ISBM) processes. However, it has been found that PET preforms comprising – in a monolayer form - BHET in a range of 5 mol% to 95 mol%, PEF/FDCA in a range of 1 mol% to 10 mol%; and recycled PET in a range of 5 mol% to 95 mol%, can provide improved processing characteristics. For example and without limitation, preforms having such a composition may provide acceptable PET plastic containers (e.g., bottles) with a total stretch ratio of about 18.5:1, or greater. Moreover, such containers may also demonstrate improved gas barrier properties – an improvement of which may, comparatively, be 5%, 10%, or even more. For example and without limitation, an embodiment such as disclosed herein with 5 mole% PEF in a 15 gram preform (e.g., 0.75 gram of PEF) might suitably replace 2.75 grams of PET. That is, rather than 17 grams of PET, one may utilize 14.25 gram of PET and 0.75 gram PEF. Such lightweighting with PEF (e.g., 5 mol% as above) in combination with comparatively high/higher stretch ratios (including some that exceed 18.5:1) can provide an article that preserves necessary or required mechanical properties in various configurations and applications.

Some embodiments of a monolayer container may comprise about 30-95 mole% of rPET and about 3-5 mole% of PEF. Moreover, embodiments of preforms, such as disclosed herein, which have at least 30 mole% rPET and other embodiments which have a minimum of 50 mole% rPET may have a total stretch ratio greater than 18.5:1. As used herein, mol%, %mol, and mole percent may be used interchangeably.

With embodiments, such disclosed BHET-PEF/FDCA-rPET compositions for preforms may provide a total/overall stretch ratio improvement of the preform in an ISBM process. Such total/overall stretch ratio improvement may be 1.1 to 1.4 times, or even more than 1.4 times, the stretch ratio associated with conventional PET preforms (e.g., preforms formed from “conventional PET composition” – a virgin PET resin such as used for beverage bottles or containers) under comparable conditions – and which may, at the same time, maintain or exceed strength and clarity parameters. “Comparable conditions” may mean the same or substantially the same ISBM conditions (e.g., same mold, same preform design, same preform weight, same temperature profile, same stretch ratios targeted, etc.). When processed with a high total stretch ratio (which may, for example, exceed 18.5) disclosed embodiments of the composition in preforms and resulting containers can yield improved gas barrier properties (for example, about 10%, or even more) and/or enhance the mechanical performance of resultant containers. Moreover, the disclosed combination may enhance recyclability and help facilitate sustainable packaging solutions. For example, embodiments of containers such as disclosed herein can provide recyclability advantages with respect to, for example, containers that include nylon-based barriers.

Various embodiments are described herein for various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments.

Reference throughout the specification to "various embodiments," "with embodiments," "in embodiments," or "an embodiment," or the like, means that a particular feature, structure, or characteristic described in connection with the embodiment is included in at least one embodiment. Thus, appearances of the phrases "in various embodiments," "with embodiments," "in embodiments," or "an embodiment," or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader’s understanding of the present disclosure, and do not create limitations, particularly as to the position, orientation, or use of embodiments.

Joinder references (e.g., attached, coupled, connected, and the like) are to be construed broadly and may include intermediate members between a connection of elements and relative movement between elements. As such, joinder references do not necessarily imply that two elements are directly connected/coupled and in fixed relation to each other. The use of "e.g." in the specification is to be construed broadly and is used to provide non-limiting examples of embodiments of the disclosure, and the disclosure is not limited to such examples. Uses of "and" and "or" are to be construed broadly (e.g., to be treated as "and/or"). For example and without limitation, uses of "and" do not necessarily require all elements or features listed, and uses of "or" are intended to be inclusive unless such a construction would be illogical.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

It is intended that all matter contained in the above description or shown in the accompanying drawings shall be interpreted as illustrative only and not limiting. Changes in detail or structure may be made without departing from the present disclosure.

What is claimed is:

1. A plastic composition comprising:
bis(2-hydroxyethyl) terephthalate (BHET);
polyethylene furanoate (PEF) or furandicarboxylic acid (FDCA); and
recycled polyethylene terephthalate (rPET);
wherein the BHET is present in an amount in a range of about 5 mol% to about 95 mol%; the PEF or FDCA is present in an amount in a range of about 1 mol% to about 10 mol%; and the rPET is present in an amount in a range of about 5 mol% to about 95 mol%.

2. The composition of claim 1, wherein the PEF or FDCA comprises PEF.

3. The composition of claim 2, wherein the PEF is present in an amount in a range of about 2 mol% to about 5 mol%.

4. The composition of claim 2, wherein the PEF is present in an amount in a range of about 3 mol% to about 4 mol%.

5. The composition of claim 1, wherein the composition is in a monolayer form.

6. The composition of claim 1, wherein the rPET comprises post-consumer recycled PET in the form of flakes.

7. The composition of claim 1, wherein the composition is configured for injection stretch blow molding of a container.

8. The composition of claim 1, wherein the composition, when injection stretch blow molded into a container, provides a total stretch ratio of at least about 18.5:1.

9. The composition of claim 8, wherein the composition provides a total stretch ratio from about 18.5:1 to at least about 1.4 times a total stretch ratio associated with a conventional virgin PET composition processed under comparable conditions.

10. The composition of claim 1, wherein the composition, when formed into a container, exhibits an oxygen or carbon dioxide gas barrier improvement of at least about 5 % relative to a container formed from a conventional virgin PET composition under comparable processing conditions.

11. The composition of claim 10, wherein the gas barrier improvement is at least about 10 %.

12. The composition of claim 1, wherein the composition, when formed into a container having a total stretch ratio greater than 18.5:1, exhibits mechanical properties sufficient for use as a beverage bottle.

13. The composition of claim 1, wherein the composition comprises at least about 30 mol% rPET.

14. The composition of claim 1, wherein the composition comprises at least about 50 mol% rPET.

15. The composition of claim 1, wherein the composition is free of nylon-based barrier layers.

16. A plastic preform comprising the composition of claim 1.

17. The preform of claim 16, wherein the preform comprises a monolayer body formed from the composition.

18. The preform of claim 16, wherein the preform has a weight of about 15 grams and comprises about 5 mol% PEF sufficient to replace about 2.75 grams of PET in a comparative 17-gram PET preform.

19. The preform of claim 16, wherein the preform is configured for injection stretch blow molding into a container having a total stretch ratio greater than about 18.5:1.

20. A method of making a plastic container, comprising:
providing recycled polyethylene terephthalate (rPET);
during or after melting the rPET, adding bis(2-hydroxyethyl) terephthalate (BHET) and polyethylene furanoate (PEF) or furandicarboxylic acid (FDCA) to form a modified PET resin comprising BHET in a range of about 5 mol% to about 95 mol%, PEF or FDCA in a range of about 1 mol% to about 10 mol%, and rPET in a range of about 5 mol% to about 95 mol%;
forming a preform from the modified PET resin; and
injection stretch blow molding the preform to form the container with a total stretch ratio exceeding about 18.5:1.

21. A method of injection stretch blow molding a plastic container, comprising:
providing a preform comprising a composition of BHET, PEF or FDCA, and rPET;
heating the preform to a temperature suitable for biaxial stretching;
inserting a stretch rod and axially stretching the preform;
introducing pressurized gas to radially expand the preform; and
forming a container with a total stretch ratio exceeding about 18.5:1.
